(19) United States
(12) Patent Application Publication
(10) Pub. No.: US 2023/0073866 A1
(43) Pub. Date: Mar. 9, 2023

(54) SEPARATION MEMBRANE MODULE

(71) Applicant: NGK INSULATORS, LTD., Nagoya-City (JP)

(72) Inventors: Takahiro NAKANISHI, Nagoya-City (JP); Katsuya SHIMIZU, Kasugai-City (JP); Naoto KINOSHITA, Nagoya-City (JP); Makiko ICHIKAWA, Nagoya-City (JP)

(73) Assignee: NGK INSULATORS, LTD., Nagoya-City (JP)

(21) Appl. No.: 18/045,485

(22) Filed: Oct. 11, 2022

Related U.S. Application Data
(63) Continuation of application No. PCT/JP2021/014506, filed on Apr. 5, 2021.

(30) Foreign Application Priority Data
Jun. 5, 2020 (JP) 2020-098750

(51) Int. Cl. B01D 65/00; B01D 63/06; B01D 71/02

(52) U.S. Cl. CPC B01D 65/003; B01D 63/066; B01D 71/0281; B01D 2313/041; B01D 2313/042; B01D 2325/22

(57) ABSTRACT

A separation membrane module includes a separation membrane complex having a support and a separation membrane provided on the support, a housing container for housing the separation membrane complex, and a sealing member existing between a supporting surface provided inside the housing container and a supported surface of the separation membrane complex, being in close contact with the supporting surface and the supported surface. A first static friction coefficient between the sealing member and the supported surface and/or a second static friction coefficient between the sealing member and the supporting surface are/is not higher than 0.5. A value obtained by multiplying the first static friction coefficient and/or the second static friction coefficient by a compressive force [N] of the sealing member and dividing the product by a mass [kg] of the separation membrane complex is larger than 0.7.

### CROSS-REFERENCE TO RELATED APPLICATIONS

The present application is a continuation application of International Application No. PCT/JP2021/014506 filed on Apr. 5, 2021, which claims priority to Japanese Patent Application No. 2020-098750 filed on Jun. 5, 2020. The contents of these applications are incorporated herein by reference in their entirety.

### TECHNICAL FIELD

The present invention relates to a separation membrane module.

### BACKGROUND ART

Conventionally, a separation membrane module has been used. Japanese Patent Application Laid Open Gazette No. 2020-23432 (Document 1), for example, discloses a separation membrane module in which a complex of zeolite and an inorganic porous support and a dense member are bonded to each other with an inorganic adhesive agent. Further, Japanese Patent Application Laid Open Gazette No. 2009-226395 (Document 2) discloses a separation membrane module in which a plurality of separation membrane elements are coupled in series and loaded in a pressure-resistant container. In the separation membrane module, a friction resistance reducing structure for reducing the friction resistance on an inner surface of the pressure-resistant container in a coupling member which couples the separation membrane elements. Furthermore, Japanese Patent Application Laid Open Gazette No. 2004-83375 (Document 3) and WO 2011/105511 (Document 4) each show a method of manufacturing a DDR-type zeolite. Further, WO 2018/180095 (Document 5) shows a method of inspecting gas leak in a separation membrane module.

In the separation membrane module, a separation membrane complex having a separation membrane and a support is supported inside a housing container. In an exemplary separation membrane module, between an inner surface of a container body of the housing container and an outer surface of the separation membrane complex, a sealing member which is in close contact with the inner surface and the outer surface is provided and the separation membrane complex is supported inside the housing container by using the sealing member. In general, a frictional force between the sealing member and the outer surface of the separation membrane complex and the inner surface of the container body is high (which means less slippery) and it is very cumbersome to exchange the sealing member. Since deterioration of the sealing member is faster than that of a separation membrane depending on the use conditions (temperature, gas type, and the like), however, it is necessary to regularly exchange the sealing member and it is required to make it easier to exchange the sealing member in order to improve the maintainability.

As shown in Japanese Patent Application Laid Open Gazette No. 2009-226395 (Document 2 described above), for example, it is possible to make the above-described frictional force lower (make the sealing member more slippery) by providing two or more projecting portions on the sealing member, but when any vibration or impact is imposed on the separation membrane module, there occurs a slip between the sealing member and the outer surface of the separation membrane complex or the inner surface of the container body and it thereby becomes impossible to appropriately support the separation membrane complex inside the housing container and ensure the hermeticity. These problems occur in the same way also in a case where the separation membrane complex is attached onto a supporting surface other than the inner surface of the container body with the sealing member interposed therebetween inside the housing container.

### SUMMARY OF THE INVENTION

The present invention is intended for a separation membrane module, and it is an object of the present invention to make it easier to attach and remove a separation membrane complex to/from a housing container while appropriately supporting the separation membrane complex in the housing container.

The separation membrane module according to the present invention includes a separation membrane complex having a support and a separation membrane provided on the support, a housing container for housing the separation membrane complex, and a sealing member existing between a supporting surface provided inside the housing container and a supported surface of the separation membrane complex, being in close contact with the supporting surface and the supported surface, and in the separation membrane module, a first static friction coefficient between the sealing member and the supported surface and/or a second static friction coefficient between the sealing member and the supporting surface are/is not higher than 0.5, and a value obtained by multiplying the first static friction coefficient and/or the second static friction coefficient by a compressive force [N] of the sealing member and dividing the product by a mass [kg] of the separation membrane complex is larger than 0.7.

According to the present invention, it is possible to easily attach and remove the separation membrane complex to/from the housing container while appropriately supporting the separation membrane complex in the housing container.

Preferably, when the separation membrane module is heated at 100° C. for 72 hours, the ratio of the gas permeance through the separation membrane complex after heating to that through the separation membrane complex before heating is not lower than 80%.

Preferably, a lubricant is applied onto a surface of the sealing member.

Preferably, when the lubricant is heated at 100° C. for 72 hours, the rate of decrease in the mass of the lubricant is not higher than 5%.

Preferably, the supporting surface is part of an inner surface of a main body of the housing container and the supported surface is part of an outer surface of the separation membrane complex.

Preferably, the separation membrane is a zeolite membrane.

Preferably, the zeolite membrane has a pore structure with eight or less-membered oxygen ring.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view showing a configuration of a separation apparatus;

FIG. 2 is a cross section of a zeolite membrane complex;

FIG. 3 is a cross section showing enlarged part of the zeolite membrane complex;

FIG. 4 is a view showing a manner of measuring a static friction coefficient between a sealing member and a supporting surface of a housing container;

FIG. 5 is a view showing a manner of measuring a static friction coefficient between the sealing member and a supported surface of the zeolite membrane complex; and

FIG. 6 is a view showing another example of a separation membrane module.

### DETAILED DESCRIPTION

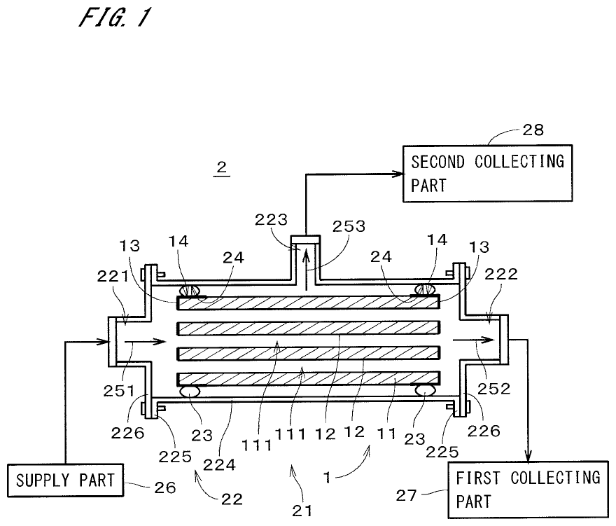

FIG. 1 is a view showing a schematic configuration of a separation apparatus 2 in accordance with one preferred embodiment of the present invention. In FIG. 1, parallel hatch lines are omitted in the cross section of some constituent elements. The separation apparatus 2 is an apparatus for separating a substance with high permeability for the zeolite membrane complex 1, which will be described later, from a fluid (i.e., gas or liquid). Separation in the separation apparatus 2 may be performed, for example, in order to extract a substance with high permeability from a fluid, or in order to concentrate a substance with low permeability.

The above-described fluid may be a type of gas or a mixed gas containing a plurality of types of gases, may be a type of liquid or a mixed liquid containing a plurality of types of liquids, or may be a gas-liquid two-phase fluid containing both a gas and a liquid.

The fluid contains at least one of, for example, hydrogen (H₂), helium (He), nitrogen (N₂), oxygen (O₂), water (H₂O), water vapor (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOx such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond and triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH3), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the fluid to be separated by the separation apparatus 2 is a mixed substance (i.e., a mixed gas) containing a plurality of types of gases.

The separation apparatus 2 includes a separation membrane module 21, a supply part 26, a first collecting part 27, and a second collecting part 28. The separation membrane module 21 includes a zeolite membrane complex 1 and a housing container 22, and two sealing members 23. The zeolite membrane complex 1 and the sealing members 23 are housed inside the housing container 22. The supply part 26, the first collecting part 27, and the second collecting part 28 are disposed outside the housing container 22 and connected to the housing container 22.

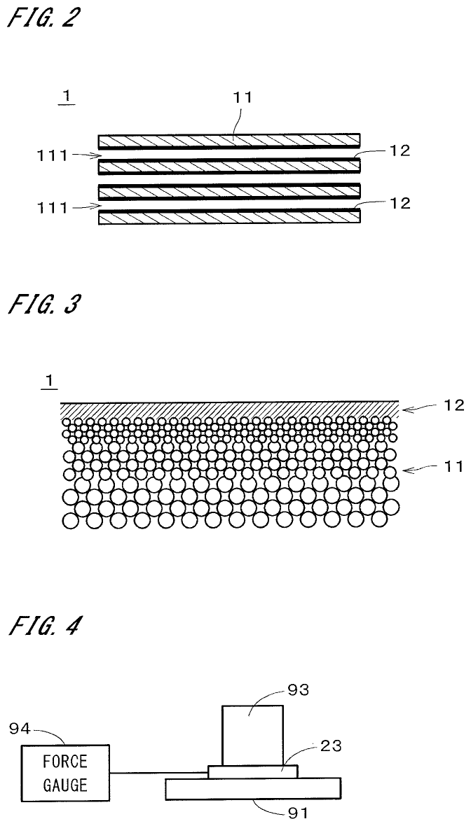

FIG. 2 is a cross section of the zeolite membrane complex 1. FIG. 3 is a cross section showing enlarged part of the zeolite membrane complex 1. In FIG. 2, a sealing part 13 described later is not shown. The zeolite membrane complex 1 is a separation membrane complex, and includes a porous support 11 and a zeolite membrane 12 which is a separation membrane provided on the support 11. The zeolite membrane 12 is at least obtained by forming zeolite on a surface of the support 11 in a membrane form and does not include a membrane obtained by simply dispersing zeolite particles in an organic membrane. Further, the zeolite membrane 12 may contain two or more types of zeolites which are different in the structure and the composition. In FIG. 2, the zeolite membrane 12 is represented by a thick line. In FIG. 3, the zeolite membrane 12 is hatched. Further, in FIG. 3, the thickness of the zeolite membrane 12 is shown larger than the actual thickness.

Furthermore, in the separation apparatus 2, a separation membrane complex other than the zeolite membrane complex 1 may be used, and instead of the zeolite membrane 12, an inorganic membrane formed of an inorganic substance other than zeolite or a membrane other than the inorganic membrane may be formed on the support 11 as the separation membrane. Further, a separation membrane in which zeolite particles are dispersed in an organic membrane may be used. In the following description, it is assumed that the separation membrane is the zeolite membrane 12.

The support 11 is a porous member that gas and liquid can permeate. In the exemplary case shown in FIG. 2, the support 11 is a monolith-type support having an integrally and continuously molded columnar main body provided with a plurality of through holes 111 each extending in a longitudinal direction (i.e., a left and right direction in FIG. 2). In the exemplary case shown in FIG. 2, the support 11 has a substantially columnar shape. A cross section perpendicular to the longitudinal direction of each of the through holes 111 (i.e., cells) is, for example, substantially circular. In FIG. 2, the diameter of each through hole 111 is larger than the actual diameter, and the number of through holes 111 is smaller than the actual number. The zeolite membrane 12 is formed over an inner surface of the through hole 111, covering substantially the entire inner surface of the through hole 111.

The length of the support 11 (i.e., the length in the left and right direction of FIG. 2) is, for example, 10 cm to 200 cm. The outer diameter of the support 11 is, for example, 0.5 cm to 200 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the zeolite membranes 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having micropores. The zeolite membrane 12 can be used as a separation membrane for separating a specific substance from a fluid in which a plurality of types of substances are mixed, by using a molecular sieving function. As compared with the specific substance, any one of the other substances is harder to permeate the zeolite membrane 12. In other words, the permeance of any other substance through the zeolite membrane 12 is smaller than that of the above specific substance.

The thickness of the zeolite membrane 12 is, for example, 0.05 μm to 30 μm, preferably 0.1 μm to 20 μm, and further preferably 0.5 μm to 10 μm. When the thickness of the zeolite membrane 12 is increased, the separation performance increases. When the thickness of the zeolite membrane 12 is reduced, the permeance increases. The surface roughness (Ra) of the zeolite membrane 12 is, for example, 5 μm or less, preferably 2 μm or less, more preferably 1 μm or less, and further preferably 0.5 μm or less.

Though there is no particular limitation on the type of zeolite forming the zeolite membrane 12, from the viewpoint of an increase in the permeance of CO₂ and an improvement in the separation performance, it is preferable that the zeolite membrane 12 should have a pore structure with eight or less-membered oxygen ring. In other words, the maximum number of membered rings of the zeolite contained in the zeolite membrane 12 should be 8 or less (for example, 6 or 8). Herein, an n-membered oxygen ring refers to a portion in which the number of oxygen atoms constituting a skeleton forming a pore is n and each oxygen atom is bonded to a later-described T atom to form a ring structure. Depending on the type of gas to be processed, the maximum number of membered rings of the zeolite may be larger than 8.

The zeolite membrane 12 is formed of, for example, DDR-type zeolite. In other words, the zeolite membrane 12 is the zeolite having a structure code of “DDR” which is designated by the International Zeolite Association. In this case, the unique pore diameter of the zeolite forming the zeolite membrane 12 is 0.36 nm×0.44 nm, and the average pore diameter is 0.40 nm. The unique pore diameter of the zeolite membrane 12 is smaller than the average pore diameter of the support 11.

The zeolite membrane 12 is not limited to the DDR-type zeolite but may be a zeolite having any other structure. The zeolite membrane 12 may be formed of, for example, AEI-type, AEN-type, AFN-type, AFV-type, AFX-type, BEA-type, CHA-type, DDR-type, ERI-type, ETL-type, FAU-type (X-type, Y-type), GIS-type, LEV-type, LTA-type, MEL-type, MFI-type, MOR-type, PAU-type, RHO-type, SAT-type, SOD-type zeolite, or the like.

The zeolite membrane 12 contains, for example, silicon (Si). The zeolite membrane 12 may contain, for example, any two or more of Si, aluminum (Al), and phosphorus (P). As the zeolite forming the zeolite membrane 12, zeolite in which atoms (T-atoms) located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the zeolite membrane 12 contains Si atoms and Al atoms, the ratio of Si/Al in the zeolite membrane 12 is, for example, not less than 1 and not more than 100,000. The Si/Al ratio is preferably 5 or more, more preferably 20 or more, and further preferably 100 or more. In short, the higher the ratio is, the better. By adjusting the mixing ratio of an Si source and an Al source in a later-described starting material solution, or the like, it is possible to adjust the Si/Al ratio in the zeolite membrane 12. The zeolite membrane 12 may contain an alkali metal. The alkali metal is, for example, sodium (Na) or potassium (K).

The permeance of CO₂ through the zeolite membrane 12 at 20° C. to 400° C. is, for example, 100 nmol/m²·s·Pa or more. Further, the ratio (permeance ratio) of the permeance of CO₂ through the zeolite membrane 12 to the leakage (amount) of N₂ at 20° C. to 400° C. is, for example, 5 or more. The permeance and the permeance ratio are those in a case where the partial pressure difference of CO₂ between the supply side and the permeation side of the zeolite membrane 12 is 1.5 MPa.

Herein, an exemplary operation flow for producing the zeolite membrane complex 1 will be described. In the production of the zeolite membrane complex 1, first, seed crystals to be used for producing the zeolite membrane 12 are prepared. For example, DDR-type zeolite powder is synthesized by hydrothermal synthesis, and the seed crystals are acquired from the zeolite powder. The zeolite powder itself may be used as the seed crystals, or may be processed by pulverization or the like, to thereby acquire the seed crystals.

Subsequently, the porous support 11 is immersed in a solution in which the seed crystals are dispersed, and the seed crystals are thereby attached onto the support 11. Alternatively, the solution in which the seed crystals are dispersed is brought into contact with a portion on the support 11 where the zeolite membrane 12 is to be formed, and the seed crystals are thereby attached onto the support 11. A seed crystal attachment support is thereby produced. The seed crystals may be attached onto the support 11 by any other method.

The support 11 on which the seed crystals are attached is immersed in a starting material solution. The starting material solution is produced, for example, by dissolving or dispersing an Si source and a structure-directing agent (hereinafter, also referred to as an “SDA”), and the like in a solvent. As the solvent of the starting material solution, for example, used is water or alcohol such as ethanol or the like. The SDA contained in the starting material solution is, for example, an organic substance. As the SDA, for example, 1-aminoadamantane can be used.

Then, the DDR-type zeolite is caused to grow from the seed crystals as nuclei by the hydrothermal synthesis, to thereby form the DDR-type zeolite membranes 12 on the support 11. The temperature in the hydrothermal synthesis is preferably 120 to 200° C. The time for hydrothermal synthesis is preferably 6 to 100 hours.

After the hydrothermal synthesis is finished, the support 11 and the zeolite membrane 12 are washed with pure water. The support 11 and the zeolite membrane 12 after being washed are dried at, for example, 80° C. After drying of the support 11 and the zeolite membrane 12 is finished, a heat treatment is performed on the zeolite membrane 12, to thereby almost completely combustion-remove the SDA in the zeolite membrane 12, and this causes micropores in the zeolite membrane 12 to pierce the zeolite membrane 12. With the above processing, the above-described zeolite membrane complex 1 is obtained.

In the exemplary zeolite membrane complex 1 of FIG. 1, the sealing part 13 is provided on both end portions of the support 11 in the longitudinal direction. The sealing part 13 is members for covering and sealing both end surfaces of the support 11 in the longitudinal direction and portions of an outer surface in the vicinity of both the end surfaces. The sealing part 13 prevents the inflow and outflow of gas from/to both the end surfaces of the support 11. The sealing part 13 is formed of, for example, glass, a resin, or a metal. The material and the shape of the sealing part 13 may be changed as appropriate. Furthermore, both ends of each through hole 111 in the longitudinal direction are not covered with the sealing parts 13, and therefore, the inflow and outflow of gas to/from the through hole 111 from/to both the ends thereof can be made.

In the separation membrane module 21 of FIG. 1, the housing container 22 is, for example, a tubular member having a substantially cylindrical shape. The housing container 22 may have any shape other than a cylindrical shape. The housing container 22 is a pressure-resistant container and formed of, for example, stainless steel or carbon steel. The longitudinal direction of the housing container 22 is substantially in parallel with the longitudinal direction of the zeolite membrane complex 1. A supply port 221 is provided at an end portion on one side in the longitudinal direction of the housing container 22 (i.e., an end portion on the left side in FIG. 1), and a first exhaust port 222 is provided at another end portion on the other side. A second exhaust port 223 is provided on a side surface of the housing container 22. The supply part 26 is connected to the supply port 221. The first collecting part 27 is connected to the first exhaust port 222. The second collecting part 28 is connected to the second exhaust port 223. An internal space of the housing container 22 is a sealed space that is isolated from the space around the housing container 22.

In the exemplary case shown in FIG. 1, the housing container 22 includes a container body 224 and two cover portions 226. The container body 224 is a substantially cylindrical member having openings at both end portions in the longitudinal direction. The container body 224 is provided with two flange portions 225. The two flange portions 225 are substantially annular disk-like portions extending radially outward from the container body 224 around the above-described two openings of the container body 224, respectively. The container body 224 and the two flange portions 225 are connected members. The two cover portions 226 are fixed to the two flange portions 225 by being bolted or the like while covering the above-described two openings of the container body 224, respectively. The two openings of the container body 224 are thereby sealed hermetically. The above-described supply port 221 is provided in the cover portion 226 on the left side in FIG. 1. The first exhaust port 222 is provided in the cover portion 226 on the right side in FIG. 1. The second exhaust port 223 is provided at the substantially center of the container body 224 in the longitudinal direction.

The two sealing members 23 are disposed around the entire circumference between an outer surface of the zeolite membrane complex 1 and an inner surface of the housing container 22 in the vicinity of both end portions of the zeolite membrane complex 1 in the longitudinal direction (in the exemplary case shown in FIG. 1, between an outer peripheral surface of the zeolite membrane complex 1 and an inner peripheral surface of the container body 224). Each of the sealing members 23 is a member formed of a material that gas cannot permeate. In the exemplary case shown in FIG. 1, the sealing member 23 has an annular shape, and is, for example, an O-ring formed of a flexible resin. The material of the sealing member 23 is, for example, perfluorinated fluororubber (FFKM), nitrile rubber (NBR), fluororubber (FKM), styrene-butadiene rubber (SBR), or the like.

Each of the sealing members 23 comes into close contact with the outer surface of the zeolite membrane complex 1 and the inner surface of the housing container 22 around the entire circumferences thereof. In the exemplary case shown in FIG. 1, the sealing members 23 come into close contact with an outer surface of the sealing part 13 and indirectly come into close contact with an outer surface of the support 11 with the sealing part 13 interposed therebetween. The portions between the sealing members 23 and the outer surface of the zeolite membrane complex 1 and between the sealing members 23 and the inner surface of the housing container 22 are sealed, and it is thereby mostly or completely impossible for gas to pass through the portions. In the separation membrane module 21, the hermeticity between the second exhaust port 223 and each of the supply port 221 and the first exhaust port 222 is ensured by the sealing members 23. A lubricant is adhered onto a surface of the sealing member 23. Details of the lubricant will be described later.

The supply part 26 supplies the mixed gas into the internal space of the housing container 22 through the supply port 221. The supply part 26 includes, for example, a blower or a pump for pumping the mixed gas toward the housing container 22. The blower or the pump includes a pressure regulating part for regulating the pressure of the mixed gas to be supplied to the housing container 22. The first collecting part 27 and the second collecting part 28 each include, for example, a storage container for storing the gas led out from the housing container 22 or a blower or a pump for transporting the gas.

When separation of the mixed gas is performed, the above-described separation apparatus 2 is used to prepare the zeolite membrane complex 1. Subsequently, the supply part 26 supplies a mixed gas containing a plurality of types of gases with different permeabilities for the zeolite membrane 12 into the internal space of the housing container 22. For example, the main component of the mixed gas includes CO₂ and N₂. The mixed gas may contain any gas other than CO₂ and N₂. The pressure (i.e., feed pressure) of the mixed gas to be supplied into the internal space of the housing container 22 from the supply part 26 is, for example, 0.1 MPaA to 20.0 MPaA. The temperature for separation of the mixed gas is, for example, 10° C. to 100° C.

The mixed gas supplied from the supply part 26 into the housing container 22 is introduced from the left end of the zeolite membrane complex 1 in FIG. 1 into the inside of each through hole 111 of the support 11 as indicated by an arrow 251. Gas with high permeability (which is, for example, CO₂, and hereinafter is referred to as a “high permeability substance”) in the mixed gas permeates the zeolite membrane 12 provided on the inner surface of each through hole 111 and the support 11, and is led out from the outer surface of the support 11. The high permeability substance is thereby separated from gas with low permeability (which is, for example, N₂, and hereinafter is referred to as a “low permeability substance”) in the mixed gas.

The gas (hereinafter, referred to as a “permeate substance”) which has permeated the zeolite membrane complex 1 and has been led out from the outer surface of the support 11 is collected by the second collecting part 28 through the second exhaust port 223 as indicated by an arrow 253. The pressure (i.e., permeate pressure) of the gas to be collected by the second collecting part 28 through the second exhaust port 223 is, for example, about 1 atmospheric pressure (0.101 MPaA).

Further, in the mixed gas, gas (hereinafter, referred to as a “non-permeate substance”) other than the gas which has permeated the zeolite membrane complex 1 passes through each through hole 111 of the support 11 from the left side to the right side in FIG. 1. The non-permeate substance is exhausted to the outside of the housing container 22 though the first exhaust port 222 and collected by the first collecting part 27 as indicated by an arrow 252. The pressure of the gas to be collected by the first collecting part 27 through the first exhaust port 222 is, for example, substantially the same as the feed pressure. The non-permeate substance may include a high permeability substance that has not permeated the zeolite membrane 12, as well as the above-described low permeability substance.

Next, details of the lubricant will be described. As described earlier, the lubricant is adhered on the surface of the sealing member 23. The lubricant is, for example, a substance in which a solid such as a thickener (a chemical agent for increasing the viscosity and the emulsion stability) or the like is added to a liquid lubricant. The lubricant is, for example, a fluorine-oil-based grease. As one example of the lubricant, used is MOLYKOTE (registered trademark) HP-500 manufactured by DuPont Toray Specialty Materials K.K.

The lubricant may be directly applied onto the surface of the sealing member 23, or may be applied onto the outer surface of the zeolite membrane complex 1 or the inner surface of the housing container 22, which are in contact with the sealing member 23, to be thereby adhered on the surface of the sealing member 23. As an example, the lubricant is adhered on almost the entire surface of the sealing member 23. The lubricant has only to be adhered on an area of the surface of the sealing member 23, which is in contact with the outer surface of the zeolite membrane complex 1, and another area thereof which is in contact with the inner surface of the housing container 22. Though there exists the lubricant between the sealing member 23 and the outer surface of the zeolite membrane complex 1 and between the sealing member 23 and the inner surface of the housing container 22, it is assumed, in the following description, that the sealing member 23 is in contact with the outer surface of the zeolite membrane complex 1 and the sealing member 23 is in contact with the inner surface of the housing container 22 even in the case where there exists the lubricant therebetween.

It is preferable that the lubricant should have low volatility. The volatility of the lubricant can be evaluated by using the volatilization rate in a case where the lubricant is laid at room temperature. In a case, for example, where the lubricant is extracted from a product container of the lubricant and laid at 25 to 30° C. for 72 hours, the ratio of the mass decrease amount of the lubricant after 72 hours have elapsed to the mass thereof before being laid (i.e., (the mass decrease amount of the lubricant)/(the mass of the lubricant before being laid)×100) is obtained as the volatilization rate. The above-described volatilization rate is, for example, not higher than 1%, preferably not higher than 0.5%, and more preferably not higher than 0.1%. It is thereby possible to suppress reduction in the separation performance in the zeolite membrane complex 1 due to adherence of a substance volatilized from the lubricant at room temperature onto the zeolite membrane 12.

It is preferable that the lubricant should have thermal stability. The thermal stability of the lubricant can be evaluated by using the rate of decrease in the mass in a case where the lubricant is heated under a predetermined condition. When an unheated lubricant is heated at 100° C. for 72 hours, for example, the ratio of the mass decrease amount of the lubricant after heating to the mass before heating (i.e., (the mass decrease amount of the lubricant)/(the mass of the lubricant before heating)×100) is obtained as the mass decrease rate. Though it is preferable that only the lubricant should be heated at that time, the lubricant and the sealing member 23 may be heated with the sealing member 23 on which a large amount of lubricant is adhered, cut off therefrom. Even in the case where the lubricant and the sealing member 23 are heated, since there typically occurs almost no change in the mass of the sealing member 23 due to the heating at the above-described temperature, the total mass decrease amount of the lubricant and the sealing member 23 can be regarded as the mass decrease amount of the lubricant. The mass decrease amount of the lubricant due to heating may be obtained by similarly heating another sealing member 23 with the lubricant removed therefrom and measuring the mass decrease amount of the sealing member 23.

The above-described mass decrease rate is, for example, not higher than 5%, preferably not higher than 3%, and more preferably not higher than 1%. It is thereby possible to suppress reduction in the separation performance in the zeolite membrane complex 1 due to adherence of a substance generated from the lubricant by heating onto the zeolite membrane 12.

The reduction in the separation performance due to the substance generated from the lubricant by heating can be evaluated by heating the separation membrane module 21 under a predetermined condition and obtaining a change in the permeance of a predetermined gas before and after heating. For example, first, the separation apparatus 2 including an unused separation membrane module 21 (unheated separation membrane module 21) is prepared. Subsequently, by supplying a mixed gas to the separation apparatus 2, the permeance of a predetermined gas contained in the mixed gas which permeates the zeolite membrane complex 1 (the amount to be collected through the second exhaust port 223, which will be hereinafter referred to simply as “gas permeance”) is measured. After that, in a state where the housing container 22 is sealed with the supply port 221, the first exhaust port 222 and the second exhaust port 223 covered, the separation membrane module 21 is heated at 100° C. for 72 hours. After the heating is completed, the gas permeance with respect to the mixed gas is measured again in the separation apparatus 2.

Then, the ratio of the gas permeance through the zeolite membrane complex 1 after hating to that through the zeolite membrane complex 1 before heating (i.e., (gas permeance after heating)/(gas permeance before heating)×100) is obtained. As the ratio becomes higher, the reduction in the separation performance is more suppressed. In the separation membrane module 21, the ratio is, for example, not lower than 80%, preferably not lower than 85%, and more preferably not lower than 90%. The ratio is normally not higher than 100%. Though the above-described gas permeating the zeolite membrane complex 1 is carbon dioxide (CO₂) gas in an exemplary case, the gas is not limited to this. In a case where the CO₂ permeance is measured, for example, a mixed gas of CO₂ and N₂ is used.

In the separation membrane module 21, the position of the zeolite membrane complex 1 is maintained (held) with respect to the housing container 22 by the sealing member 23. In the exemplary case shown in FIG. 1, the zeolite membrane complex 1 is not in contact with any members other than the sealing member 23 inside the housing container 22. Further, the outer surface at both the end portions of the zeolite membrane complex 1, i.e., the outer surface of the sealing part 13 is a flat cylindrical surface with respect to the longitudinal direction. In other words, in the outer surface, any recessed portion or the like for holding the sealing member 23 is not formed. Therefore, a relative position of the zeolite membrane complex 1 and the sealing member 23 is maintained by the friction between the outer surface of the zeolite membrane complex 1 (a supported surface 14 described later) and the surface of the sealing member 23. Furthermore, at positions opposed to both the end portions of the zeolite membrane complex 1, the inner surface of the housing container 22 is a flat cylindrical surface with respect to the longitudinal direction. In other words, in the inner surface, any recessed portion or the like for holding the sealing member 23 is not formed. Therefore, a relative position of the sealing member 23 and the housing container 22 is maintained by the friction between the surface of the sealing member 23 and the inner surface of the housing container 22.

Thus, in the separation membrane module 21 of FIG. 1, the position of the zeolite membrane complex 1 with respect to the housing container 22 is maintained by the friction between the outer surface of the zeolite membrane complex 1 and the sealing member 23 and the friction between the sealing member 23 and the inner surface of the housing container 22. In the following description, a portion 14 (the outer surface of the sealing part 13 in the exemplary case of FIG. 1) which is in contact with the sealing member 23 in the outer surface of the zeolite membrane complex 1 is referred to as a “supported surface 14” and a portion 24 which is in contact with the sealing member 23 in the inner surface of the housing container 22 is referred to as a “supporting surface 24”. The supported surface 14 and the supporting surface 24 are opposed to each other with the sealing member 23 interposed therebetween. In the exemplary case shown in FIG. 1, the supported surface 14 and the supporting surface 24 each have an annular shape. Further, in a case where no sealing part 13 is provided in the zeolite membrane complex 1, the supported surface 14 may be the surface of the support 11.

As described earlier, in the separation membrane module 21, the mixed gas supplied from the supply port 221 is separated into the permeate substance permeating the zeolite membrane complex 1 and being led to the second exhaust port 223 and the non-permeate substance not permeating the zeolite membrane complex 1 and being lead to the first exhaust port 222. Further, the hermeticity between the second exhaust port 223 and each of the supply port 221 and the first exhaust port 222 is ensured by the sealing member 23.

Herein, in a case where any vibration or impact is imposed on the separation membrane module 21, if there occurs a slip between the sealing member 23 and the supporting surface 24 or the supported surface 14 and the zeolite membrane complex 1 or the sealing member 23 largely moves with respect to the housing container 22, there is a possibility that the hermeticity cannot be maintained. Further, there is also another possibility that the sealing member 23 is removed from the zeolite membrane complex 1 and the zeolite membrane complex 1 hits the housing container 22, to be thereby damaged. Therefore, even in the case where any vibration or impact is imposed on the separation membrane module 21, it is preferable that the relative position of the zeolite membrane complex 1 and the sealing member 23 with respect to the housing container 22 should be maintained and the zeolite membrane complex 1 should be appropriately supported inside the housing container 22.

In order for the zeolite membrane complex 1 and the sealing member 23 not to move with respect to the housing container 22 due to the vibration or impact imposed on the separation membrane module 21, it is necessary that a frictional force F1 between the sealing member 23 and each of the supported surface 14 and the supporting surface 24 should be larger than a force F2 (hereinafter, referred to as an “impact force F2”) given to the longitudinal direction due to the vibration or impact. Herein, the frictional force F1 is expressed by Expression 1 and the impact force F2 is expressed by Expression 2.

$$frictional force F 1 = ( static friction coefficient ) \times ( normal force [ N ] due to sealing member ) = ( static friction coefficient ) \times ( compressive force [ N ] of sealing member ) = ( static friction coefficient ) \times ( compressive force [ N / m ] of sealing member per 1 m ) \times ( total contact length [ m ] of sealing member ) \qquad ( Expression 1 )$$

$$impact force F 2 = ( mass [ kg ] of zeolite membrane complex ) \times ( vibration acceleration [ m / {s}^{2} ] ) \qquad ( Expression 2 )$$

The condition for causing the zeolite membrane complex not to move when some vibration acceleration is given is thereby expressed by Expression 3.

(static friction coefficient)×(compressive force [N/m] of sealing member per 1 m)×(total contact length [m] of sealing member)/(mass [kg] of zeolite membrane complex)>(vibration acceleration [m/s²]) (Expression 3)

In Expression 1 and Expression 3, “the compressive force of the sealing member per 1 m” depends on the hardness, the wire diameter, and the squeeze of the sealing member 23, and may adopt, for example, a value disclosed by the sealing member maker or may be obtained by experiment. In Expression 1 and Expression 3, “the total contact length of the sealing member” is the length in which the sealing member is in contact with the supported surface or the supporting surface, and in the case, for example, where the sealing member is an O-ring and this is the length of contact with the supported surface 14, the total contact length of the sealing member is obtained by Expression 4.

total contact length [m] of sealing member=(inner diameter [m] of sealing member)×π×(the number of sealing members) (Expression 4)

The squeeze of the sealing member 23 is designated by MS standards. In Examples described later, used is a sealing member of P-180 and A50, having a squeeze of 0.65 and a wire diameter of 8.4. Further, in Expression 2 and Expression 3, “the vibration acceleration” depends on the magnitude of the vibration. In later-described Examples, set is vibration of 0.7 to 1 m/s² which corresponds to 97 to 100 dB. In a case where a predetermined value is determined for “the vibration acceleration” in accordance with the specification or the like required for the separation membrane module 21, as “the static friction coefficient” becomes larger, “the compressive force of the sealing member” (a value obtained by multiplying “the compressive force of the sealing member per 1 m” by “the total contact length of the sealing member”) becomes larger, or “the mass of the zeolite membrane complex” becomes smaller, the zeolite membrane complex 1 and the sealing member 23 become harder to move with respect to the housing container 22. Therefore, as a value obtained by multiplying “the static friction coefficient” by “the compressive force of the sealing member” and dividing the product by “the mass of the zeolite membrane complex” becomes larger, the separation membrane module 21 becomes more resistant to the vibration or impact and it becomes easier to maintain the state where the hermeticity is ensured.

Also after the vibration or impact is imposed, in order to appropriately support the zeolite membrane complex 1 inside the housing container 22 and maintain the hermeticity by the sealing member 23, a value obtained by multiplying the static friction coefficient (hereinafter, referred to as a “first static friction coefficient”) between the sealing member 23 and the supported surface 14 by the compressive force [N] of the sealing member and dividing the product by the mass [kg] of the zeolite membrane complex 1 is, for example, larger than 0.7, preferably not smaller than 0.9, and more preferably not smaller than 1.0. Similarly, a value obtained by multiplying the static friction coefficient (hereinafter, referred to as a “second static friction coefficient”) between the sealing member 23 and the supporting surface 24 by the compressive force [N] of the sealing member and dividing the product by the mass [kg] of the zeolite membrane complex 1 is, for example, larger than 0.7, preferably not smaller than 0.9, and more preferably not smaller than 1.0.

In a case, for example, where the hermeticity is maintained between the second exhaust port 223 and each of the supply port 221 and the first exhaust port 222 also after a predetermined vibration or impact is imposed, it is understood that the zeolite membrane complex 1 is appropriately supported inside the housing container 22. For checking the hermeticity, an inspection method shown in, for example, WO 2018/180095 (Document 5), which is incorporated herein by reference, can be used. In the method, in a state where the first exhaust port 222 is closed, an inspection gas is supplied from the supply port 221. The inspection gas has a dynamic molecular diameter larger than the pore diameter of the zeolite membrane 12. When the inspection gas reaches a predetermined pressure inside the housing container 22, the supply port 221 is closed. Subsequently, the leak amount of inspection gas to the second exhaust port 223 is acquired. The leak amount of inspection gas is, for example, calculated on the basis of a pressure change of the inspection gas on the side of the supply port 221. When the leak amount of inspection gas is lower than a predetermined threshold value, it is determined that the hermeticity is ensured by the sealing member 23, and when the leak amount of inspection gas is not lower than the predetermined threshold value, it is not determined that the hermeticity is ensured. Further, since the leak amount of inspection gas strictly includes the amount of leak due to a membrane defect of the zeolite membrane 12 as well as the amount of leak due to the sealing member 23, the leak amount to be used for determination may be the leak amount exclusive of the amount of leak due to the membrane defect. The amount of leak due to the membrane defect is calculated, for example, on the basis of a calculation formula obtained by experiment.

The first and second static friction coefficients are measured, for example, by using sheet-like or plate-like members formed of the same materials as those of the zeolite membrane complex 1 and the housing container 22 so as to have the same surface states (surface roughnesses (Ra)) as those of the zeolite membrane complex 1 and the housing container 22, respectively, and the actual sealing member 23. In the separation membrane module 21, the surface roughness (Ra) of the surface of the sealing member 23 is, for example, 1 μm to 100 μm and preferably 5 μm to 20 μm. The surface roughness (Ra) of the supported surface 14 in the zeolite membrane complex 1 is, for example, 5 μm to 100 μm and preferably 10 μm to 50 μm. The surface roughness (Ra) of the supporting surface 24 in the housing container 22 is, for example, 1 μm to 50 μm and preferably 5 μm to 20 μm. For the measurement of the surface roughness, for example, a laser microscope is used.

FIG. 4 is a view showing a manner of measuring the second static friction coefficient between the sealing member 23 and the supporting surface 24 of the housing container 22. In the exemplary case shown in FIG. 4, a plate member 91 formed of the same material as that of the supporting surface 24 (container body 224) of the housing container 22 so as to have the same surface state as that of the supporting surface 24 is placed on a predetermined horizontal plane. Further, on the plate member 91, the actual sealing member 23 is superposed. At that time, the same as the lubricant used in the separation membrane module 21 is applied on a plane of the sealing member 23, which is in contact with the plate member 91. It is preferable that the amount of application of the lubricant should be 0.01 g to 1 g. On the sealing member 23, superposed is a weight 93 (e.g., a weight having a mass of 1 kg or more). The sealing member 23 and the weight 93 may be fixed to each other as necessary. Further, a force gauge 94 is connected to the sealing member 23 (or the weight 93 fixed to the sealing member 23). Then, the sealing member 23 is drawn in a horizontal direction through the force gauge 94, and a force F [N] (hereinafter, referred to as a “force at a yield point”) obtained when the sealing member 23 is moved is measured. The second static friction coefficient μ is obtained from Expression 5.

μ=F/{(mass [kg] of sheet+mass [kg] of weight)×acceleration of gravity} (Expression 5)

Though the second static friction coefficient is measured by using the member equivalent to the housing container 22 in the exemplary case shown in FIG. 4, the first static friction coefficient may be measured by using a member equivalent to the zeolite membrane complex 1, as described above. Further, the first and second static friction coefficients may be measured by using respective fragments obtained by cutting the zeolite membrane complex 1 and the housing container 22, and in a case where a large-scale measurement apparatus can be used, measurement may be performed by using the separation membrane module 21 itself (without being cut). Since the static friction coefficient does not depend on the area of a contact surface, the same result can be obtained by any of the above-described measurement methods.

FIG. 5 is a view showing a manner of measuring the first static friction coefficient between the sealing member 23 and the supported surface 14 of the zeolite membrane complex 1. In the exemplary case shown in FIG. 5, the actual sealing member 23 is placed on a surface plate 95. The sealing member 23 may be fixed onto the surface plate 95 as necessary. The lubricant is applied onto the sealing member 23. Further, a fragment (e.g., having a mass of 1 kg or more) obtained by cutting the zeolite membrane complex 1 is placed on the sealing member 23 so that only the portion of the sealing part 13 may be in contact therewith. In FIG. 5, the same reference sign as that of the zeolite membrane complex 1 is given to the fragment of the zeolite membrane complex 1. As necessary, a weight may be superposed on the fragment and the fragment and the weight may be fixed to each other. Then, the fragment is drawn in the horizontal direction through the force gauge 94, and a force F [N] (a “force at the yield point”) obtained when the fragment is moved is measured. The first static friction coefficient μ can be obtained in the same way as Expression 5. The same applies to a case where the measurement is performed by using a fragment obtained by cutting the housing container 22.

When the zeolite membrane complex 1 is attached to the housing container 22, for example, the zeolite membrane complex 1 is disposed inside the container body 224 with the cover portion 226 taken off and the sealing member 23 is inserted between the inner surface of the container body 224 (the supporting surface 24) and the outer surface of the zeolite membrane complex 1 (the supported surface 14) from the openings at both the end portions of the container body 224 in the longitudinal direction. After that, the cover portion 226 is attached on the container body 224.

Further, in the separation membrane module 21, since the sealing member 23 is deteriorated depending on the type, the temperature, or the like of mixed gas, it is necessary to regularly exchange the sealing member 23. There are some cases where the separation membrane module 21 is broken down and maintenance is performed thereon. In such a case, first, the cover portion 226 is taken off from the container body 224. After that, the sealing member 23 is pulled out from between the inner surface of the container body 224 (the supporting surface 24) and the outer surface of the zeolite membrane complex 1 (the supported surface 14) through the openings at both the end portions of the container body 224. The zeolite membrane complex 1 is thereby removed from the housing container 22.

In order to easily attach or remove the zeolite membrane complex 1 to/from the housing container 22, the first static friction coefficient between the sealing member 23 and the supported surface 14 is, for example, not higher than 0.5, preferably not higher than 0.4, and more preferably not higher than 0.3. In this case, between the sealing member 23 and the supported surface 14, the frictional force F1 (maximum static frictional force) is, for example, not higher than 250 N, preferably not higher than 200 N, and more preferably not higher than 150 N. Similarly, the second static friction coefficient between the sealing member 23 and the supporting surface 24 is, for example, not higher than 0.5, preferably not higher than 0.4, and more preferably not higher than 0.3. In this case, between the sealing member 23 and the supporting surface 24, the frictional force F1 is, for example, not higher than 250 N, preferably not higher than 200 N, and more preferably not higher than 150 N.

As described above, in the separation membrane module 21, provided is the sealing member 23 which exists between the supporting surface 24 provided inside the housing container 22 and the supported surface 14 of the zeolite membrane complex 1, being in close contact with the supporting surface 24 and the supported surface 14, and has a surface on which the lubricant is adhered. Then, the first static friction coefficient between the sealing member 23 and the supported surface 14 and the second static friction coefficient between the sealing member 23 and the supporting surface 24 are each not higher than 0.5. Further, a value obtained by multiplying each of the first static friction coefficient and the second static friction coefficient by the compressive force [N] of the sealing member 23 and dividing the product by the mass [kg] of the zeolite membrane complex 1 is larger than 0.7. Even in the case where any vibration or impact is imposed on the separation membrane module 21, it is thereby possible to appropriately support the zeolite membrane complex 1 inside the housing container 22. Further, it is possible to easily attach or remove the zeolite membrane complex 1 to/from the housing container 22. As a result, it becomes possible to easily perform assembly, maintenance, or the like of the separation membrane module 21 and to achieve an improvement in the productivity and the maintainability of the separation membrane module 21.

Further, in the case where the separation membrane module 21 is heated at 100° C. for 72 hours, the ratio of the gas permeance through the zeolite membrane complex 1 after heating to that through the zeolite membrane complex 1 before heating is not lower than 80%. It is thereby possible to provide the separation membrane module 21 which makes it possible to suppress the reduction in the separation performance due to the lubricant. Furthermore, in the case where the lubricant is heated at 100° C. for 72 hours, the rate of decrease in the mass of the lubricant is not higher than 5%. It is thereby possible to further suppress the reduction in the separation performance in the separation membrane module 21.

Next, Examples of the separation membrane module will be described. Herein, in the manufacture of the zeolite membrane complex, first, a monolith support is prepared. The support has a diameter of 180 mm and a total length of 1000 mm. In the support, a sealing part formed of glass is formed on both end surfaces in the longitudinal direction and on an outer surface in the vicinity of both the end surfaces. Further, on the basis of the method of manufacturing the DDR-type zeolite shown in Japanese Patent Application Laid Open Gazette No. 2004-83375 (Document 3), which is incorporated herein by reference, DDR-type zeolite crystal powder is produced and used as the seed crystals. After dispersing the seed crystals in water, coarse particles are removed and a seed crystal dispersion liquid is thereby produced. Next, on the basis of the method shown in WO 2011/105511 (Document 4), which is incorporated herein by reference, produced is a zeolite membrane complex having a diameter of 180 mm and a total length of 1000 mm.

Further, a sealing member and a housing container are prepared. The sealing member is a rubber O-ring with a Shore hardness of A50, having an inner diameter of 179.5 mm and a wire diameter of 8.4 mm (P-180 in P standard). Furthermore, the diameter of the inner surface of the housing container is designed, in accordance with JISB2401, so that the squeeze of the sealing member can be 0.65 mm. Then, the zeolite membrane complex is attached inside the housing container by using the sealing member and a separation membrane module is thereby obtained. At that time, in the separation membrane module of Examples 1 to 3, a lubricant is applied onto a surface of the sealing member. The lubricant used in Example 1 is MOLYKOTE (registered trademark) HP-500 manufactured by DuPont Toray Specialty Materials K.K, the lubricant used in Example 2 is MOLYKOTE (registered trademark) high vacuum grease, and the lubricant used in Example 3 is Sumilon 2250 spray manufactured by Sumico Lubricant Co., Ltd. In the separation membrane module of Comparative Example 1, no lubricant is applied on the sealing member.

(Measurement of the First Static Friction Coefficient Between the Zeolite Membrane Complex and the Sealing Member)

On the sealing member, a fragment obtained by cutting the zeolite membrane complex is superposed so that a supported surface of the fragment may be in contact with the sealing member. At that time, the same lubricants as used in Examples 1 to 3, respectively, are each applied onto an interface on which the sealing member and the supported surface of the zeolite membrane complex come into contact with each other. In Comparative Example 1, no lubricant is applied onto the interface. Then, the fragment is drawn in the horizontal direction through a force gauge and the force F [N] at the yield point is measured. The first static friction coefficient is obtained from Expression 5 described earlier. Table 1 shows the first static friction coefficient.

TABLE 1

| | | | Force at | First Static |
|---|---|---|---|---|
| | Lubricant | Mass | Yield Point | Friction |
| | Type | [kg] | [N] | Coefficient |
| Example 1 | MOLYKOTE | 1.326 | 1.6 | 0.12 |
| | HP-500 | | | |
| Example 2 | MOLYKOTE | 1.439 | 3.4 | 0.24 |
| | High Vacuum | | | |
| | Grease | | | |
| Example 3 | Sumilon | 1.448 | 2.8 | 0.20 |
| | Spray | | | |
| Comparative | None | 1.444 | 10.5 | 0.74 |
| Example 1 | | | | |

With each of the lubricants used in Examples 1 to 3, the first static friction coefficient not higher than 0.25 is obtained while in Comparative Example 1 using no lubricant, the first static friction coefficient is higher than 0.7.

(Measurement of the Second Static Friction Coefficient Between the Housing Container and the Sealing Member)

The sealing member is superposed on a plate member (100×100 mm) formed of the same material as that of a container body (supporting surface) of the housing container so as to have the same surface state as that of the supporting surface. At that time, the same lubricants as used in Examples 1 to 3, respectively, are each applied onto a surface of the sealing member, which comes into contact with the plate member. In Comparative Example 1, no lubricant s applied onto the surface. Subsequently, a weight having a mass of 1.2 kg is placed on the sealing member and fixed thereto with adhesive double-sided tape. Then, the weight is drawn in the horizontal direction through the force gauge and the force F [N] at the yield point is measured. The second static friction coefficient is obtained from Expression 5 described earlier. Table 2 shows the second static friction coefficient.

TABLE 2

| | | | Force at | Second Static |
|---|---|---|---|---|
| | Lubricant | Mass | Yield Point | Friction |
| | Type | [kg] | [N] | Coefficient |
| Example 1 | MOLYKOTE | 1.399 | 2.1 | 0.15 |
| | HP-500 | | | |
| Example 2 | MOLYKOTE | 1.399 | 1.9 | 0.14 |
| | High Vacuum | | | |
| | Grease | | | |
| Example 3 | Sumilon | 1.399 | 4.7 | 0.34 |
| | Spray | | | |
| Comparative | None | 1.399 | 10.6 | 0.77 |
| Example 1 | | | | |

With each of the lubricants used in Examples 1 to 3, the second static friction coefficient not higher than 0.35 is obtained while in Comparative Example 1 using no lubricant, the second static friction coefficient becomes higher than 0.7. Though both the first static friction coefficient and the second static friction coefficient in Examples 1 to 3 are each not higher than 0.5 in the present test, either one of the first and second static friction coefficients has only to be not higher than 0.5 in terms of maintainability.

(Evaluation of the Separation Performance Before and After Heating)

A mixed gas of carbon dioxide (CO₂) and nitrogen (N₂) (assuming that the volume ratio of these gases is 50:50 and the partial pressure of each gas is 0.2 Mpa) is introduced to the separation membrane module of Examples 1 to 3 and Comparative Example 1, and the permeation flow rate of gas permeating the zeolite membrane complex is measured by a mass flow meter. Further, component analysis is performed on the gas which has permeated the zeolite membrane complex by using a gas chromatograph and the CO₂ concentration in the gas is thereby obtained. Then, the CO₂ permeance is obtained by multiplying the gas permeation flow rate by the CO₂ concentration. Subsequently, a supply port, a first exhaust port, and a second exhaust port (see reference signs 221 to 223 in FIG. 1) are covered in the housing container, and in the state where the housing container is sealed, the separation membrane module is heated at 100° C. for 72 hours. After that, the CO₂ permeance is obtained in the same way as that before heating, and the ratio (%) of the CO₂ permeance after heating to that before heating is obtained. Table 3 shows the ratio of the CO₂ permeance after heating to that before heating.

TABLE 3

| | Lubricant | Ratio of CO₂ Permeance |
|---|---|---|
| | Type | After Heating to That Before Heating [%] |
| Example 1 | MOLYKOTE | 91.1 |
| | HP-500 | |
| Example 2 | MOLYKOTE | 87.3 |
| | High Vacuum | |
| | Grease | |
| Example 3 | Sumilon | 45.4 |
| | Spray | |
| Comparative | None | 100.0 |
| Example 1 | | |

In the separation membrane module of Examples 1 and 2 and Comparative Example 1, the ratio of the CO₂ permeance after heating to that before heating is not lower than 85% while in the separation membrane module of Example 3, the ratio is 45%.

(Evaluation of the Thermal Stability of the Lubricant)

The lubricants of about 10 to 30 mg, which are used in Examples 1 to 3, are extracted, and the thermogravimetry (TG) is performed thereon, to thereby obtain the mass decrease rate. In the thermogravimetry, TG-DTA2000SA manufactured by Bruker is used. Further, as the measurement condition, it is assumed that the atmosphere is N₂ 200 ml/min, the maximum attainable temperature is 100° C., the rate of temperature rise is 100° C./h, and the keep condition is 100° C. and 72 h. The mass decrease rate is obtained as the ratio of the mass decrease amount due to heating to the mass of the lubricant before heating. Table 4 shows the mass decrease rate of the lubricant.

TABLE 4

| | | Mass | Mass | Mass |
|---|---|---|---|---|
| | | Before | Decrease | Decrease |
| | Lubricant | Heating | Amount | Rate |
| | Type | [mg] | [mg] | [%] |
| Example 1 | MOLYKOTE | 22.3 | 0.001 | 0.004 |
| | HP-500 | | | |
| Example 2 | MOLYKOTE | 28.0 | 0.263 | 0.9 |
| | High Vacuum | | | |
| | Grease | | | |
| Example 3 | Sumilon | 25.6 | 7.53 | 29.4 |
| | Spray | | | |

With each of the lubricants used in Examples 1 and 2, the mass decrease rate is not higher than 1.0% while with the lubricant used in Example 3, the mass decrease rate is higher than 29%.

(Evaluation of the Volatility of the Lubricant)

The lubricants of about 10 to 30 mg, which are used in Examples 1 to 3, are extracted from the product containers, and laid at 25 to 30° C. for 72 hours. The ratio of the mass decrease amount after being laid to the mass of the lubricant before being laid is obtained as the volatilization rate. Table 5 shows the volatilization rate of the lubricant.

TABLE 5

| | | Mass | Mass | |
|---|---|---|---|---|
| | | Before | Decrease | Volatilization |
| | Lubricant | Being Laid | Amount | Rate |
| | Type | [mg] | [mg] | [%] |
| Example 1 | MOLYKOTE | 22.3 | 0.001 | 0.004 |
| | HP-500 | | | |
| Example 2 | MOLYKOTE | 28.0 | 0.003 | 0.01 |
| | High Vacuum | | | |
| | Grease | | | |
| Example 3 | Sumilon | 25.6 | 6.14 | 24.0 |
| | Spray | | | |

With each of the lubricants used in Examples 1 and 2, the volatilization rate is not higher than 0.01% while with the lubricant used in Example 3, the volatilization rate is higher than 23%.

(Evaluation of the Hermeticity Before and After the Vibration Test)

Three types of zeolite membrane complexes having different masses are prepared and each attached to the housing container by using the sealing member, to thereby produce the separation membrane module. In Examples 1-1 and 1-2 and Comparative Example 2, the lubricant of Example 1 is applied onto the sealing member, and in Examples 2-1, 2-2, and 2-3, the lubricant of Example 2 is applied onto the sealing member. Further, in Examples 3-1, 3-2, and 3-3, the lubricant of Example 3 is applied onto the sealing member, and in Comparative Examples 1-1, 1-2, and 1-3, no lubricant is applied onto the sealing member. Among the three types of zeolite membrane complexes, the zeolite membrane complex having the smallest mass is used for Examples 1-1, 2-1, and 3-1 and Comparative Example 1-1, the zeolite membrane complex having the second smallest mass is used for Examples 1-2, 2-2, and 3-2 and Comparative Example 1-2, and the zeolite membrane complex having the largest mass is used for Comparative Example 2, Examples 2-3 and 3-3, and Comparative Example 1-3.

First, the hermeticity in the separation membrane module is checked by the inspection using the inspection gas. The inspection method is the same as that shown in WO 2018/180095 (Document 5) as described above. Before the vibration test, in all the separation membrane modules, it is confirmed that the hermeticity is ensured by the sealing member. Subsequently, the separation membrane module is placed on a large-scale vibration apparatus, and vibrations with vibration acceleration levels of 97, 99, and 100 dB and accelerations of 0.71, 0.89, 1.00 m/s² are given. After that, the hermeticity in the separation membrane module is checked again. Table 6 shows the hermeticity after the vibration test and a value obtained by (static friction coefficient×compressive force of sealing member)/mass of separation membrane complex. Further, in the columns of “First Static Friction Coefficient” and “Second Static Friction Coefficient” of Table 6, “a (circle)” is shown when the static friction coefficient (see Table 1 and Table 2) obtained for each lubricant type (including “none”) is not higher than 0.5 and “x (cross)” is shown when the static friction coefficient is higher than 0.5.

TABLE 6

| | | | | (Static Friction | | | |
|---|---|---|---|---|---|---|---|
| | | | | Coefficient × | | | |
| | | | | Compressive Force | Hermeticity After Vibration Test | | |
| | | First Static | Second Static | of Sealing Member)/ | 97 dB | 99 dB | 100 dB |
| | Lubricant | Friction | Friction | Mass of Separation | Vibration | Vibration | Vibration |
| | Type | Coefficient | Coefficient | Membrane Complex | Test | Test | Test |
| Example 1-1 | MOLYKOTE | ◯ | ◯ | 1.92 | ◯ | ◯ | ◯ |
| Example 1-2 | HP-500 | | | 0.91 | ◯ | ◯ | X |
| Comparative | | | | 0.69 | X | X | X |
| Example 2 | | | | | | | |
| Example 2-1 | MOLYKOTE | ◯ | ◯ | 2.16 | ◯ | ◯ | ◯ |
| Example 2-2 | High Vacuum | | | 1.02 | ◯ | ◯ | ◯ |
| Example 2-3 | Grease | | | 0.77 | ◯ | X | X |
| Example 3-1 | Sumilon | ◯ | ◯ | 3.08 | ◯ | ◯ | ◯ |
| Example 3-2 | Spray | | | 1.46 | ◯ | ◯ | ◯ |
| Example 3-3 | | | | 1.10 | ◯ | ◯ | ◯ |
| Comparative | None | X | X | 12.07 | ◯ | ◯ | ◯ |
| Example 1-1 | | | | | | | |
| Comparative | | | | 5.72 | ◯ | ◯ | ◯ |
| Example 1-2 | | | | | | | |
| Comparative | | | | 4.30 | ◯ | ◯ | ◯ |
| Example 1-3 | | | | | | | |

In the column of “Hermeticity After Vibration Test” of Table 6, “∘” shows that the hermeticity is ensured and “x” shows that the hermeticity is not ensured. Further, in the columns of “(Static Friction Coefficient×Compressive Force of Sealing Member)/Mass of Separation Membrane Complex”, shown is a value obtained by multiplying the static friction coefficient by the compressive force [N] of the sealing member and dividing the product by the mass [kg] of the zeolite membrane complex. As “(Static Friction Coefficient×Compressive Force of Sealing Member)/Mass of Separation Membrane Complex”, respective values of (static friction coefficient×compressive force of sealing member)/mass of separation membrane complex are obtained from the first static friction coefficient of Table 1 and the second static friction coefficient of Table 2 which are acquired for each lubricant type (including “none”) and the smaller one among the two values is shown. In the separation membrane module of all Examples and Comparative Examples except Comparative Example 2, the hermeticity is ensured even after the vibration test with the vibration acceleration level of 97 dB. Though the conditions under the actual use environment are different from those in the present test since gases of various temperatures and pressures come into contact, impact values given in the present test are determined in consideration of these differences and if the hermeticity is ensured in the present test, it can be thought that there occurs no positional difference even under the use environment. From this, if a value obtained by multiplying the first and second static friction coefficients by the compressive force [N] of the sealing member and dividing the product by the mass [kg] of the zeolite membrane complex is larger than 0.7, it can be thought that the zeolite membrane complex can be appropriately supported inside the housing container even after the vibration test of 97 dB. In terms of maintaining the hermeticity for larger vibration, the value of (static friction coefficient×compressive force of sealing member)/mass of separation membrane complex is preferably not lower than 0.9, and more preferably not lower than 1.0.

In the above-described separation membrane module 21, various modifications can be made.

Depending on the design of the separation membrane module 21, an annular recessed portion in which the sealing member 23 is disposed may be provided in the inner surface of the housing container 22 shown in FIG. 1. In this case, since the sealing member 23 is held inside the recessed portion, in order to easily attach and remove the zeolite membrane complex 1 to/from the housing container 22 while appropriately supporting the zeolite membrane complex 1 inside the housing container 22, it is important that the first static friction coefficient between the sealing member 23 and the supported surface 14 of the zeolite membrane complex 1 is not higher than 0.5 and the value obtained by multiplying the first static friction coefficient by the compressive force [N] of the sealing member and dividing the product by the mass [kg] of the zeolite membrane complex 1 is larger than 0.7.

Similarly, an annular recessed portion in which the sealing member 23 is disposed may be provided in the outer surface of the zeolite membrane complex 1. In this case, since the sealing member 23 is held inside the recessed portion, it is important that the second static friction coefficient between the sealing member 23 and the supporting surface 24 of the housing container 22 is not higher than 0.5 and the value obtained by multiplying the second static friction coefficient by the compressive force [N] of the sealing member and dividing the product by the mass [kg] of the zeolite membrane complex 1 is larger than 0.7. Thus, it is important that the static friction coefficient between a surface among the supported surface 14 and the supporting surface 24, which is not provided with the recessed portion in which the sealing member 23 is housed, and the sealing member 23 is not higher than 0.5 and the value obtained by multiplying the static friction coefficient by the compressive force [N] of the sealing member 23 and dividing the product by the mass [kg] of the separation membrane complex (the zeolite membrane complex 1 in the above description) is larger than 0.7. In other words, in the separation membrane module 21, the first static friction coefficient between the sealing member 23 and the supported surface 14 of the zeolite membrane complex 1 and/or the second static friction coefficient between the sealing member 23 and the supporting surface 24 of the housing container 22 should be not higher than 0.5 and the value obtained by multiplying the first static friction coefficient and/or the second static friction coefficient by the compressive force [N] of the sealing member and dividing the product by the mass [kg] of the separation membrane complex should be larger than 0.7. If the above-described conditions can be satisfied, application of the lubricant onto the sealing member 23 may be omitted.

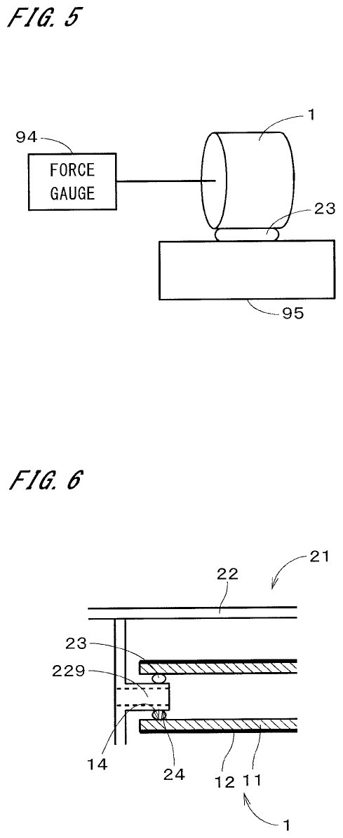

Though the supporting surface 24 is part of the inner surface in the container body 224 of the housing container 22 in the separation membrane module 21 shown in FIG. 1, there may be a configuration, for example, as shown in FIG. 6, where a substantially cylindrical supporting part 229 fixed to the housing container 22 is provided and an annular outer surface (which may be an inner surface) provided on the supporting part 229 is used as the supporting surface 24. Further, though the supported surface 14 is part of the outer surface of the zeolite membrane complex 1 in the exemplary case shown in FIG. 1, there may be a configuration, for example, like in the zeolite membrane complex 1 of FIG. 6, where a tubular support 11 is used and an inner surface of the support 11 is used as the supported surface 14. In the exemplary case shown in FIG. 6, the inner surface of the support 11 is opposed to the annular outer surface of the above-described supporting part 229 and the annular sealing member 23 is in close contact with the inner surface of the support 11 and the annular outer surface of the above-described supporting part 229 between these surfaces, and the zeolite membrane complex 1 is thereby supported inside the housing container 22.

The zeolite membrane complex 1 may further include a function layer or a protective layer laminated on the zeolite membrane 12, additionally to the support 11 and the zeolite membrane 12. Such a function layer or a protective layer may be an inorganic membrane such as a zeolite membrane, a silica membrane, a carbon membrane, or the like or an organic membrane such as a polyimide membrane, a silicone membrane, or the like. Further, a substance that is easy to adsorb specific molecules such as CO₂ or the like may be added to the function layer or the protective layer laminated on the zeolite membrane 12.

The separation membrane module 21 may be used for separation from the mixture of any substances other than the substances exemplarily shown in the above description.

The configurations in the above-discussed preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation membrane module of the present invention can be used for separation of various fluids.

### REFERENCE SIGNS LIST

1 Zeolite membrane complex
11 Support
12 Zeolite membrane
14 Supported surface
21 Separation membrane module
22 Housing container
23 Sealing member
24 Supporting surface
224 Container body

1. A separation membrane module, comprising:
a separation membrane complex having a support and a separation membrane provided on said support;
a housing container for housing said separation membrane complex; and
a sealing member existing between a supporting surface provided inside said housing container and a supported surface of said separation membrane complex, being in close contact with said supporting surface and said supported surface;
wherein a first static friction coefficient between said sealing member and said supported surface and/or a second static friction coefficient between said sealing member and said supporting surface are/is not higher than 0.5, and
a value obtained by multiplying said first static friction coefficient and/or said second static friction coefficient by a compressive force [N] of said sealing member and dividing the product by a mass [kg] of said separation membrane complex is larger than 0.7.

2. The separation membrane module according to claim 1, wherein
when said separation membrane module is heated at 100° C. for 72 hours, the ratio of the gas permeance through said separation membrane complex after heating to that through said separation membrane complex before heating is not lower than 80%.

3. The separation membrane module according to claim 1, wherein
a lubricant is applied onto a surface of said sealing member.

4. The separation membrane module according to claim 3, wherein
when said lubricant is heated at 100° C. for 72 hours, the rate of decrease in the mass of said lubricant is not higher than 5%.

5. The separation membrane module according to claim 1, wherein
said supporting surface is part of an inner surface of a main body of said housing container and said supported surface is part of an outer surface of said separation membrane complex.

6. The separation membrane module according to claim 1, wherein
said separation membrane is a zeolite membrane.

7. The separation membrane module according to claim 6, wherein
said zeolite membrane has a pore structure with eight or less-membered oxygen ring.
